(19) United States
(12) Patent Application Publication
(10) Pub. No.: US 2007/0001453 A1
(43) Pub. Date: Jan. 4, 2007

(54) Protection cover for quick connector

(76) Inventors: Atsuo Miyajima, Inuyama-shi (JP); Keiji Matsuno, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/481,394

(22) Filed: Jul. 5, 2006

(30) Foreign Application Priority Data
Jul. 4, 2005 (JP) 2005-194892

(51) Int. Cl. F16L 39/00

(52) U.S. Cl. 285/319

(57) ABSTRACT

A protection cover is adapted for a quick connector that has an inserting portion in which a mating pipe is inserted in an axial direction of the inserting portion, a retainer for stopping withdrawal of the inserting portion from the pipe, and a nipple portion to be press-fitted in a tube. The protection cover has a cylindrical portion as protection body made from inflexible rigid material and a fixing part to the quick connector. The protection cover protects the nipple portion from outside such that the cylindrical portion covers an outer periphery of the nipple portion with a spacing defined between an inner peripheral surface of the cylindrical portion and an outer peripheral surface of the tube.

### BACKGROUND OF THE INVENTION

1. Field of the Invention

The present invention relates to a protection cover for a quick connector to be adapted for connecting a piping tube and a mating pipe, more specifically, a protection cover for the quick connector for protecting a nipple portion of the quick connector from damage.

2. Description of the Related Art

Previously, for connecting a piping tube, specifically, a resin tube and a mating pipe, a quick connector that permits simple and quick connection with the mating pipe has been used widely as a coupling.

FIGS. 13 and 14 show an example of specific construction of the quick connector.

In FIGS. 13 and 14, reference numeral 200 indicates a resin tube for piping, reference numeral 202 indicates a mating pipe (here, made of metal) to be connected with the resin tube 200.

The mating pipe 202 is formed with a bulging portion 204 of an annular shape, bulging radially outwardly on an outer peripheral surface thereof.

Reference numeral 206 indicates a quick connector (here, made of resin) that has a connector body 208 and a retainer 210.

The connector body 208 includes a tubular inserting portion 214 that defines an inserting space 212 inside in which the mating pipe 202 is inserted, and a nipple portion 216 that has a diameter smaller than the inserting portion 214.

The nipple portion 216 has an outer peripheral surface that is provided with annular biting teeth 218 at a plurality of axially spaced positions. The annular biting teeth 218 have saw-toothed cross-section with acute angled peaks.

The nipple portion 216 are press-fitted in the tube 200 with the biting teeth 218 biting an inner surface of the tube 200. Their biting action securely fixes the nipple portion 216 to the tube 200, and stops the nipple portion 216 with respect to the tube 200 for preventing withdrawal.

Meanwhile, the nipple portion 216 is formed with an annular holding groove on a leading end portion of an outer peripheral surface thereof, in which an elastic O-ring 220 is held as a sealing ring. The O-ring 220 provides a liquid-tight seal between the nipple portion 216 and the tube 200.

Inside the inserting portion 214, elastic O-rings 222, 222 as sealing rings and a bush 224 are held. The O-rings 222, 222 provide a liquid-tight seal between the inserting portion 214 and the mating pipe 202 that is inserted in the insertion space 212.

The above connector body 208 has a socket-like retainer holding portion 226 on a left end portion or left edge side thereof in FIG. 13.

The retainer holding portion 226 is a portion that holds the retainer 210 inside in receiving relation, and the connector body 208 is connected to the mating pipe 202 via the retainer 210.

The retainer holding portion 226 has window portions 228 of arcuate shape and stop portions 230 also of arcuate shape. Stopper recesses 232 of the retainer 210 fit to the stop portions 230 from radially inside, and thereby the retainer 210 is held in the retainer holding portion 226 in axially fixed relation.

The retainer 210 is a generally annular member as a whole, and is resiliently deformable in a radial direction.

The retainer 210 is formed with engaging recessed portions 234. The bulging portion 204 of the mating pipe 202 fits in the engaging recessed portions 234 from radially inside, and thereby the mating pipe 202 is securely fixed in an axial direction.

Namely, such retainer 210 provides a stop for the inserting portion 214 in the axial direction with respect to the mating pipe 202 that is inserted in the inserting portion 214.

The tube 200 is connected with the mating pipe 202 with use of the quick connector 206 in the following manner. First, the nipple portion 216 is press-fitted in the tube 200 and securely fixed thereto (refer to FIG. 14), and the retainer 210 is held in the retainer holding portion 226. Then, in this state, the mating pipe 202 is inserted in the inserting portion 214. As such, the tube 200 and the mating pipe 202 can be easily connected.

When the mating pipe 202 is inserted in the inserting portion 214, the bulging portion 204 of the mating pipe 202 engages with the engaging recessed portions 234 of the retainer 210, the connector body 208 and the mating pipe 202 are brought into axially fixed relation. At this time, the mating pipe 202 and the connector body 208 are liquid-tightly sealed by the O-rings 222, 222.

This type of the quick connector 206 is widely used, for example, for connection of a tube in piping of a motor vehicle, such as fuel transporting piping of a motor vehicle. However, in the quick connector 206, the nipple portion 216 as a press-fit portion into the tube 200 has a small diameter. Therefore, at the time of collision of motor vehicles, in case where the quick connector 206 strongly or swiftly contacts against peripheral components and a great external force acts on the nipple portion 216, there is a fear that a large stress acts intensively on a base region of the nipple portion 216, and the nipple portion 216 is broken at its base region.

So, in case where the quick connector 206 is applied for connection of a tube for fuel transporting piping, a problem arises that fuel inside leaks out of the broken base region.

The present invention is made in order to solve such problem.

Meanwhile, Patent Document 1 below discloses a prior art related to the present invention.

However, according to a disclosure of Patent Document 1, a rubber tubular protector is fitted on an outer peripheral surface of a resin tube in order to protect the resin tube from mechanical shock when the resin tube or a motor vehicle is hit with pebbles during driving and to enhance flammability resistance. An object to be protected by the tubular protector is not a quick connector and is different from that of the present invention.

[Patent Document 1] JP-A, 9-217877

Under the circumstances described above, it is an object of the present invention to provide a protection cover for a quick connector that can effectively prevent that a nipple portion is broken or damaged at a base region thereof when a great external force acts on the quick connector.

### SUMMARY OF THE INVENTION

According to the present invention, there is provided a novel protection cover for a quick connector that comprises (a) an inserting portion defining an inserting space inside in which a mating pipe is inserted in an axial direction of the inserting portion, (b) a retainer resiliently deformable in a radial direction for stopping withdrawal of the inserting portion from the pipe, and (c) a nipple portion having a diameter smaller than the inserting portion and including a biting tooth on an outer peripheral surface of the nipple portion. The nipple portion is or is formed so as to be press-fitted in a tube for piping and securely fixed to the tube in stopped relation with the biting tooth biting an inner surface of the tube. The protection cover comprises a cylindrical portion as protection body made from inflexible rigid material, and a fixing part to the quick connector. The cylindrical portion covers or is formed so as to cover an outer periphery of the nipple portion with spacing defined along an entire circumference between an inner peripheral surface of the cylindrical portion and an outer peripheral surface of the tube that is fitted on the nipple portion to protect the nipple portion from outside.

According to one aspect of the present invention, the fixing part has a claw projecting radially inwardly for fit-engaging in a groove in an outer peripheral surface of the quick connector to fix the protection cover to the quick connector in an axial direction thereof.

According to one aspect of the present invention, the protection cover is made of metal, and the claw of the fixing part fit-engages in or is formed so as to fit-engage in the groove by swaging, for example, the claw, the fixing part, or the protection cover.

According to one aspect of the present invention, the fixing part has a resilient piece resilient radially and the claw provided on the resilient piece, and the claw fit-engages in or is formed so as to fit-engage in the groove by sliding the fixing part in an axial direction, for example, with respect to the quick connector with the resilient piece being resiliently deformed.

According to one aspect of the present invention, the protection cover is split into split bodies combined or split in a direction perpendicular to an axis thereof, and each of the split bodies is provided with a joint portion for combining the split bodies with one another in the direction perpendicular to the axis.

According to one aspect of the present invention, a tube protector made of an elastic material is fitted on the tube in covering relation, and the spacing defined between the cylindrical portion and the tube affords sufficient space for the tube protector to be inserted, disposed or located therein.

As stated above, a protection cover comprises a cylindrical portion as protection body made of inflexible rigid material, and a fixing part for securely fixing the protection cover to the quick connector. The protection cover is securely fixed to the quick connector by the fixing part. And, the cylindrical portion covers an outer periphery of a nipple portion with a spacing defined between an inner peripheral surface of the cylindrical portion and an outer peripheral surface of the tube to protect the nipple portion from outside. According to the present invention, when a great external force acts on a connecting region between the tube and the mating pipe at the time of collision of motor vehicles, the external force can be borne by the protection cover. And, since the spacing is defined between the protection cover and the tube (or the tube protector), it is prevented or restrained that the external force is transmitted to the nipple portion.

This favorably can prevent that the nipple portion is broken or damaged at a base region thereof.

In the present invention, the fixing part of the above protection cover may be formed so as to have a claw projecting radially inwardly for fit-engaging in a groove in an outer peripheral surface of the quick connector to fix the protection cover to the quick connector in the axial direction thereof.

In this manner, the protection cover can be easily securely fixed to the quick connector by fit-engaging the claw in the groove of the quick connector.

In this case, the protection cover may be made of metal, a part of the protection cover may be deformed so as to be diametrically contracted, or be swaged so that the claw fit-engages in the groove of the quick connector.

In this manner, the protection cover can have a firm fixing strength with respect to the quick connector.

On the other hand, the fixing part may be configured to have a resilient piece resilient radially, and the claw provided on the resilient piece. And the claw may fit-engage in the groove of the quick connector by sliding the fixing part in an axial direction, for example, with respect to the quick connector with the resilient piece being resiliently deformed, and thereby the protection cover can be securely fixed to the quick connector.

In case where the protection cover has to be securely fixed to the quick connector by swaging, a problem arises that a cost becomes high due to need of equipment for fixing by swaging. However, in case where the fixing part has a resilient piece and a claw thereon, the protection cover can be easily securely fixed to the quick connector simply by sliding the fixing part or the protection cover in an axial direction. And, equipment for securely fixing by swaging can be unnecessary, and the cost can be lowered.

In one aspect of the present invention, the protection cover may be split into split bodies combined or split in a direction perpendicular to an axis thereof, and each of the split bodies may be provided with a joint portion for combining the split bodies with one another in the direction perpendicular to the axis.

In this construction, there is an advantage that the protection cover can be attached to the quick connector after the nipple portion of the quick connector is relatively press-fitted in the tube and securely fixed thereto.

Namely, in case where the protection cover is securely fixed to the quick connector by swaging, typically, the protection cover is swaged and securely fixed to the quick connector before the nipple portion is press-fitted in and securely fixed to the tube. Also, in case where the fixing part has a resilient piece and a claw thereon, when the protection cover is in a form of a unitary tubular body, the protection cover also has to be fitted on the tube prior to press-fitting of the nipple portion in the tube. On the contrary, when the protection cover is in a form of split bodies, there is an advantage that the protection cover can be attached to the quick connector after the nipple portion is fitted in the tube and the quick connector is connected to the tube.

In the present invention, a tube protector made of an elastic material may be fitted on the tube in covering relation, and a spacing that affords sufficient space for the tube protector to be inserted, disposed or located therein is preferably secured between the cylindrical portion and the tube.

In this manner, the protection cover can cover and protect from outside the tube with or and the tube protector protecting its outer peripheral surface. Here, there is an advantage that the protection cover can be attached on the quick connector or the tube protector can be attached on the tube without daringly removing an end portion of the tube protector.

Now, the preferred embodiments of the present invention will be described in detail with reference to the drawings.

### BRIEF DESCRIPTION OF THE DRAWINGS

FIG. 1 is a view showing a protection cover for a quick connector according to first embodiment of the present invention in attached state.

FIG. 2 is a perspective view of the protection cover of the first embodiment in attached state.

FIG. 3 is an exploded perspective view showing each component shown in FIGS. 1 and 2.

FIG. 4 is an exploded sectional view of each component (partly omitted) shown in FIGS. 1 and 2.

FIG. 5 (a) is an explanatory view of steps of attaching the protection cover of the first embodiment on the quick connector, and showing a state just before a nipple portion is fitted in a tube.

FIG. 5 (b) is the explanatory view of the steps of attaching the protection cover of the first embodiment on the quick connector, and showing a state that a tube protector is being inserted between the tube and the protection cover.

FIG. 5 (c) is the explanatory view of the steps of attaching the protection cover of the first embodiment on the quick connector, and showing a state that the tube protector is inserted inside the protection cover.

FIG. 6 is a view showing a protection cover for a quick connector according to second embodiment of the present invention in attached state.

FIG. 7 is a perspective view of the protection cover of the second embodiment in attached state.

FIG. 8 (a) is an explanatory view of steps of attaching the protection cover of the second embodiment on the quick connector, and showing that the protection cover is slidingly moved over a tube with a tube protector fitted thereon toward the quick connector.

FIG. 8 (b) is an explanatory view of the steps of attaching the protection cover of the second embodiment on the quick connector, and showing a state that the protection cover is securely fixed to the quick connector in an axial direction.

FIG. 9 is a view showing a protection cover for a quick connector according to third embodiment of the present invention in attached state.

FIG. 10 is a perspective view of the protection cover of the third embodiment in attached state.

FIG. 11 (a) is a view of the protection cover of the third embodiment alone, and showing a split body of the protection cover.

FIG. 11 (b) is a view of the protection cover of the third embodiment alone, and showing a pair of the split bodies that are combined each other in a direction perpendicular to an axis.

FIG. 12 (a) is an explanatory view of steps of attaching the protection cover of the third embodiment on the quick connector, and showing a state before the pair of the split bodies are combined each other.

FIG. 12 (b) is the explanatory view of the steps of attaching the protection cover of the third embodiment on the quick connector, and showing a state that the pair of the split bodies are being combined each other.

FIG. 12 (c) is the explanatory view of the steps of attaching the protection cover of the third embodiment on the quick connector, and showing a state that the pair of the split bodies are combined each other.

FIG. 13 is a view showing an example of a conventional quick connector.

FIG. 14 (a) is an explanatory view of steps of connecting the quick connector of FIG. 13 to a tube by press-fitting, and showing a state before a nipple portion is press-fitted in the tube.

FIG. 14 (b) is the explanatory view of the steps of connecting the quick connector to the tube by press-fitting, and showing that the nipple portion is press-fitted in the tube.

### DETAILED DESCRIPTION OF THE PREFERRED EMBODIMENTS

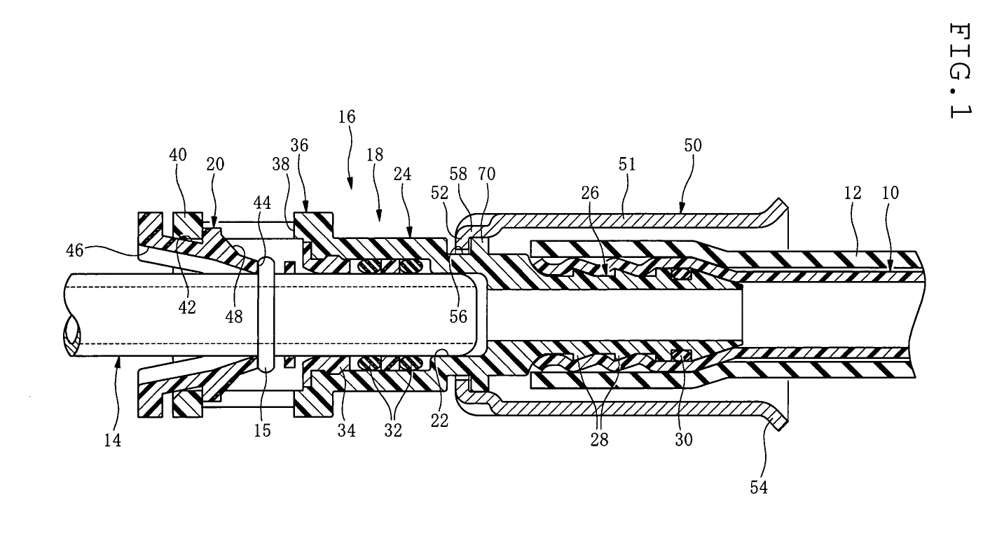

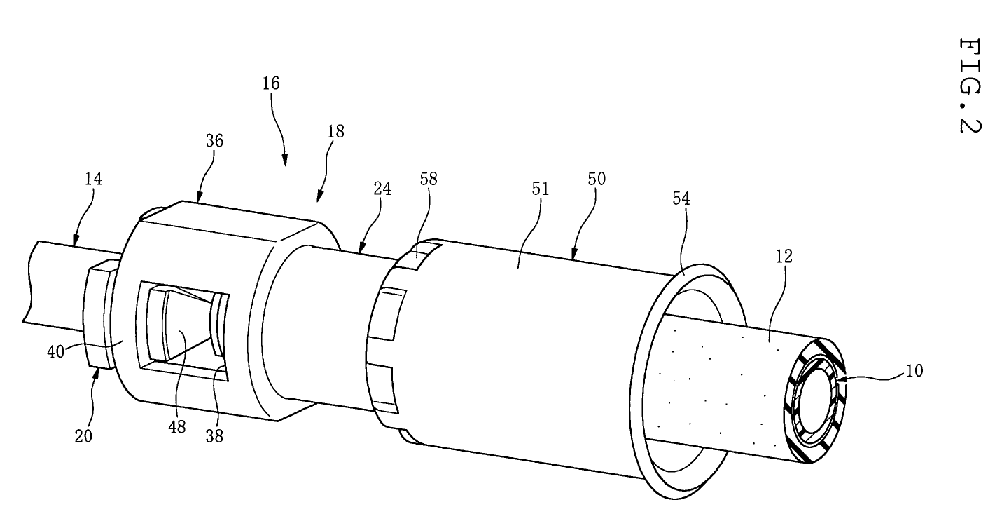

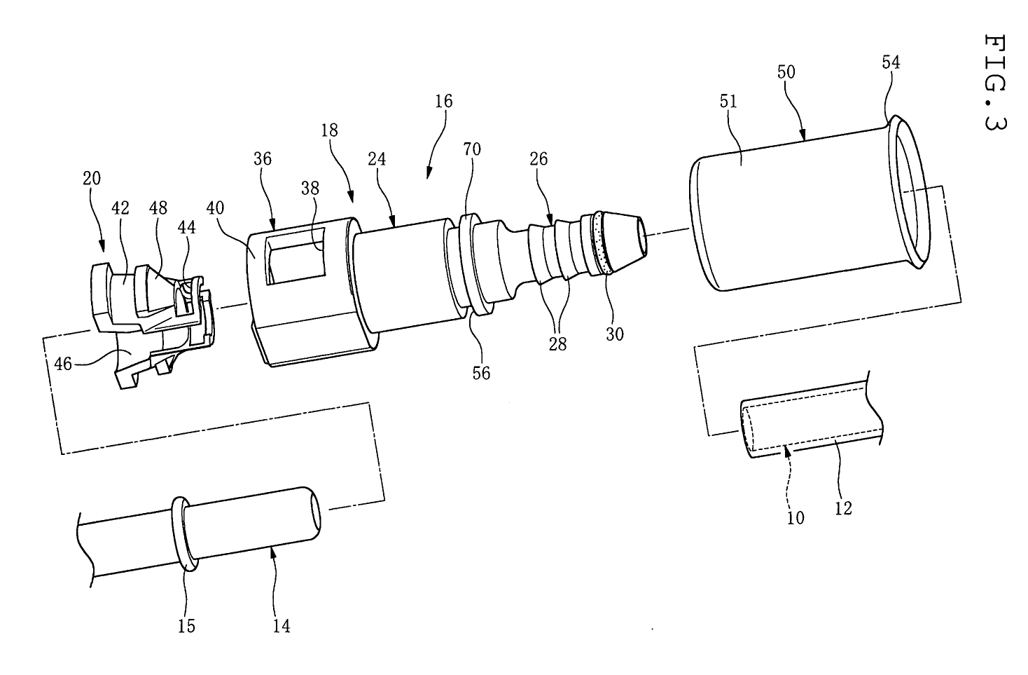

FIGS. 1 to 4 show a protection cover for a quick connector of first embodiment. In the figures, reference numeral 10 indicates a resin tube (here, a tube for piping transporting fuel of a motor vehicle), and reference numeral 12 indicates a tube protector made of rubber that is fitted on an outer peripheral surface of the tube 10 in covering relation.

The tube protector 12 covers the tube 10 and functions to protect the tube 10, specifically, to protect the tube 10 from breakage or damage due to mechanical shock when the tube 10 or a motor vehicle is hit with pebbles and to compensate for low flammability resistance of the tub 10.

Reference numeral 14 indicates a mating pipe (here, made of metal) and is formed with a bulging portion 15 of an annular shape, bulging radially outwardly on an outer peripheral surface thereof.

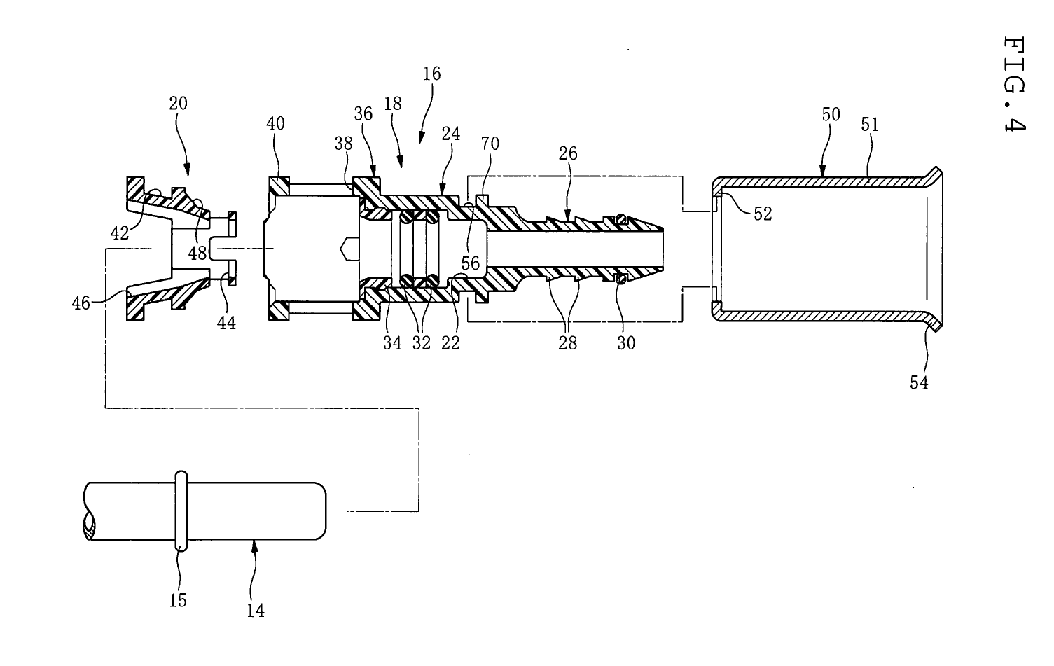

Reference numeral 16 indicates a quick connector made of resin as coupling joint. As also shown in FIG. 4, the quick connector 16 has a connector body 18 and a retainer 20.

The connector body 18 has a tubular inserting portion 24 that internally defines an inserting space 22 in which the mating pipe 14 is inserted, and a nipple portion 26 that has a diameter smaller than that of the inserting portion 24.

The nipple portion 26 is a portion to be press-fitted inside the tube 10, and has an outer peripheral surface that is provided with annular biting teeth 28 at a plurality of axially spaced positions. The annular biting teeth 28 have saw-toothed cross-section with acute angled peaks, respectively.

The nipple portion 26 is press-fitted in the tube 10 with the biting teeth 28 biting in an inner surface of the tube 10. And, their biting action securely fixes the nipple portion 26 to the tube 10, and stops the nipple portion 26 with respect to the tube 10 for preventing withdrawal.

Meanwhile, the nipple portion 26 is formed with an annular holding groove on an outer peripheral surface of a leading end portion thereof, in which an elastic O-ring 30 is held as a sealing ring. The O-ring 30 provides a liquid-tight seal between the nipple portion 26 and the tube 10.

On the other hand, inside the inserting portion 24, elastic O-rings 32, 32 as sealing rings and a bush 34 are held. The O-rings 32, 32 elastically contact with an outer peripheral surface of the mating pipe 14 that is inserted in the insertion space 22, and provide a liquid-tight seal between the mating pipe 14 and the inserting portion 24.

The connector body 18 also has a socket-like retainer holding portion 36 on a left end portion of the inserting portion 24 in the figures.

The retainer holding portion 36 is a portion that holds the retainer 20 inside in receiving relation, and the connector body 18 is connected with the mating pipe 14 via the retainer 20.

The retainer holding portion 36 has window portions 38 of arcuate shape and stop portions 40 also of arcuate shape. A stopper recess 42 of the retainer 20 fits to the stop portions 40 from radially inside, and thereby the retainer 20 is held in the retainer holding portion 36 in axially fixed relation.

The retainer 20 is a generally annular member as a whole, and is resiliently deformable in a radial direction.

The retainer 20 is formed with engaging recessed portions 44. The bulging portion 15 of the mating pipe 14 fits in the engaging recessed portions 44 from radially inside, and thereby the mating pipe 14 and the retainer 20, namely the mating pipe 14 and the connector body 18 via this retainer 20 are securely fixed each other in axially stopped relation.

The retainer 20 further includes generally tapered inner peripheral cam surfaces or tapered inner peripheral guide surfaces 46, and generally tapered outer peripheral cam surfaces or tapered outer peripheral guide surfaces 48.

Here, when the mating pipe 14 is inserted in the retainer 20 in the axial direction, the inner peripheral cam surfaces 46 guide the bulging portion 15 for axial movement, and resiliently diametrically enlarges the retainer 20, for example, as a whole, to allow the bulging portion 15 to pass to a position of the engaging recessed portions 44.

On the other hand, when the retainer 20 is inserted in the retainer holding portion 36 of the connector body 18 in the axial direction, the outer peripheral cam surfaces 48 resiliently diametrically contract the retainer 20, for example, as a whole, to allow the stopper recess 42 to fit to the stop portions 40 of the retainer holding portion 36.

Reference numeral 50 indicates a protection cover (here, made of metal) for the quick connector 16, and has a cylindrical portion 51 of cylindrical shape as a whole as a protection body or protection body portion, and a claw or claws 52 projecting radially inwardly as fixing part or parts to the quick connector 16.

The cylindrical portion 51 has a reverse-tapered portion 54 on a right end portion in FIG. 1, that guides the tube 10 when the nipple portion 26 is press-fitted in the tube 10.

FIG. 1 shows that the protection cover 50 is attached on and securely fixed to the quick connector 16.

As shown in FIG. 1, in the first embodiment, by diametrically contracting or deforming (swaging) a left end portion of the protection cover 50 in FIG. 1 radially inwardly, the claw or claws 52 are fit-engaged in the quick connector 16, specifically in an annular groove 56 formed in an outer peripheral surface of the inserting portion 24, and thereby the protection cover 50 is attached on the quick connector 16 in axially fixed relation.

In FIG. 1, reference numeral 58 indicates a swaged portion.

As shown in FIG. 1, the protection cover 50 has a sufficient length to cover the nipple portion 26 entirely.

Specifically, the protection cover 50 has such length that its leading end protrudes beyond a leading end of the nipple portion 26 for a certain length toward a right-hand in FIG. 1.

And, the cylindrical portion 51 has such a shape as to define a spacing between an inner peripheral surface of the cylindrical portion 51 and an outer peripheral surface of the tube 10 along an entire circumference thereof, when the protection cover 50 is attached as shown in FIG. 1.

That is, the protection cover 50 has a sufficiently large diametrical dimension (diameter) with respect to the nipple portion 26.

In this first embodiment, a diameter of the protection cover 50 is determined such that a proper annular spacing is defined also between the cylindrical portion 51 of the protection cover 50 and the tube protector 12.

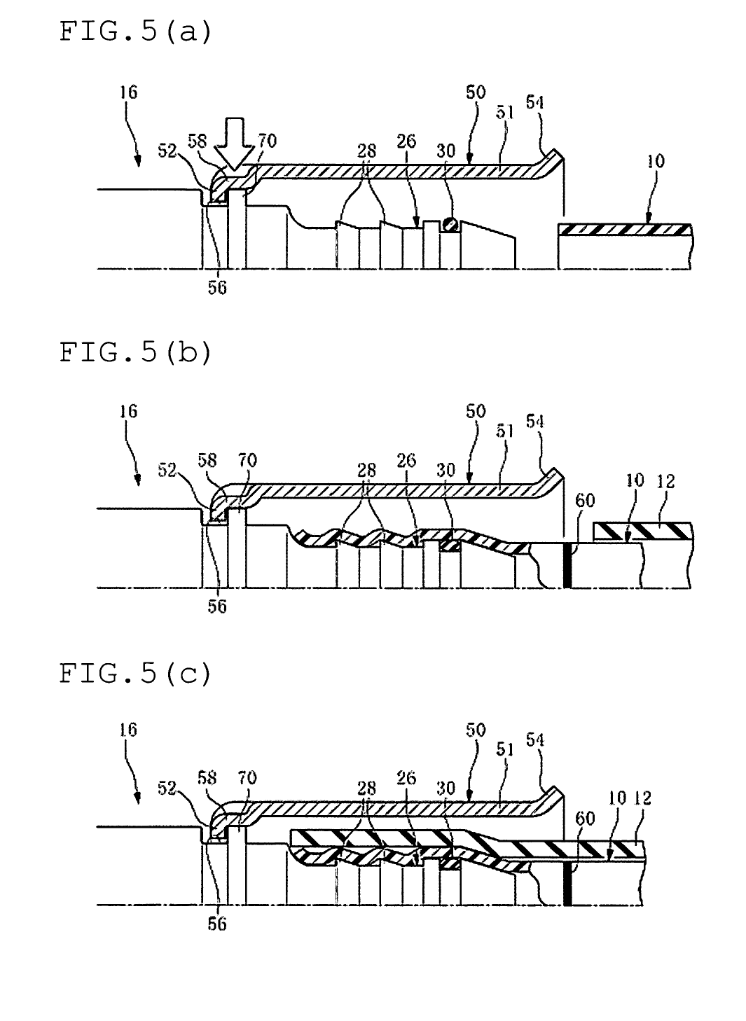

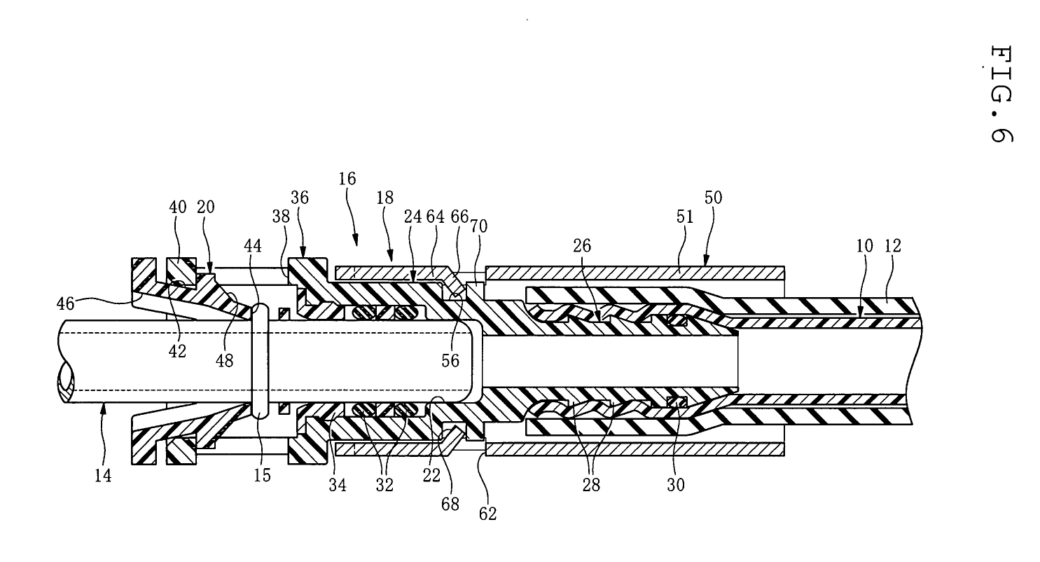

FIGS. 5 (a) to 5 (c) show steps of attaching the protection cover 50 on the quick connector 16 and press-fitting the quick connector 16 in the tube 10 for connection.

Meanwhile, a paint mark 60 is placed on a portion of an outer peripheral surface of the tube 10, just exposed out of a right end of the protection cover 50 axially to the right side in the figure, for verifying a press-fit position or extent.

As described later, the paint mark 60 is adapted for verifying whether the nipple portion 26 is correctly press-fitted in the tube 10 for necessary (press-fitted) length while the protection cover 50 is attached on the quick connector 16.

As shown in FIG. 5, in the first embodiment, the protection cover 50 is first securely fixed to the quick connector 16 by swaging the swaging portion 58.

In this state, as shown in FIG. 5 (a), the nipple portion 26 of the quick connector 16 is press-fitted inside the tube 10, and thereby the quick connector 16 is connected to the tube 10.

At that time, an operator visually checks that the paint mark 60 placed on an outer surface of the tube 10 is located corresponding to or adjacent to a position of an axial edge of the protection cover 50, and thereby can verify that the nipple portion 26 is sufficiently correctly press-fitted in the tube 10.

Then, as shown in FIG. 5 (b), the tube protector 12 that has been already fitted on the tube 10 is moved in an axial direction (to the left in the figure), and its leading end portion is inserted in an annular spacing defined between the tube 10 and the protection cover 50.

FIG. 5 (c) shows a state that the tube protector 12 is inserted inside the protection cover 50 in this manner.

According to the protection cover 50 for the quick connector 16 of the first embodiment as stated above, even when a great external force acts on or with respect to a connecting region between the tube 10 and the mating pipe 14 at the time of collision of motor vehicles, the external force can be borne by the protection cover 50. And since the spacing is defined between the protection cover 50 and the tube 10, it can be blocked or restrained that the external force is transmitted to the nipple portion 26.

This can favorably prevent that the nipple portion 26 is broken or damaged at a base region thereof.

And, in the first embodiment, the protection cover 50 is provided with a claw or claws 52 projecting radially inwardly, the claw or claws 52 fit-engage in a groove 56 in an outer peripheral surface of the quick connector 16, and thereby the protection cover 50 is securely fixed to the quick connector 16 in the axial direction. So, the protection cover 50 is easily fixed to the quick connector 16.

Further, since the claw or claws 52 are configured to fit-engage in the groove 56 by swaging the protection cover 50, a fixing strength of the protection cover 50 with respect to the quick connector 16 can be reinforced.

In the first embodiment, the space is secured between the protection cover 50 and the tube 10 that allows the tube protector 12 to be inserted therein. The protection cover 50 covers and protects the tube 10 with or and the tube protector 12 fitted thereon, from outside, more specifically, the protection cover 50 is attached on the quick connector 16 or the tube protector 12 is properly located on the tube 10 without daringly removing an end portion of the tube protector 12, specifically, to be located inside the protection cover 50.

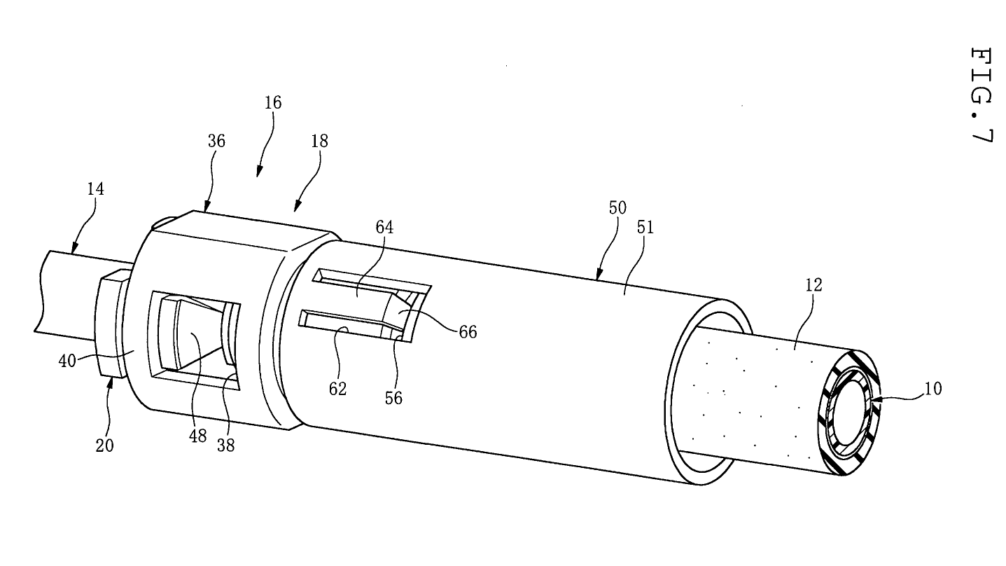

FIGS. 6 to 8 show a protection cover of second embodiment of the present invention.

In the second embodiment, the protection cover 50 for the quick connector 16 is made of inflexible rigid resin (or metal) and has a unitary cylindrical shape.

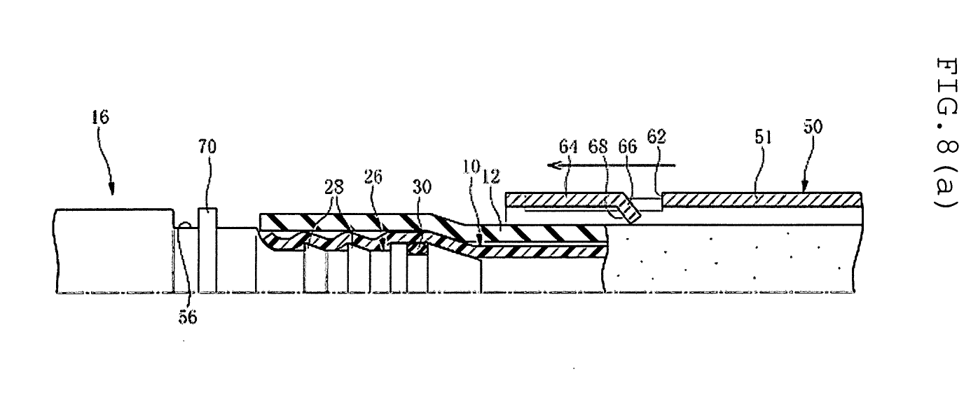

As shown in FIG. 7, the protection cover 50 is formed with cutout portions 62 of generally horseshoe shape that define resilient pieces 64, respectively.

As shown in FIG. 6, a leading end portion of the resilient piece 64, which is bent or turned radially inwardly, forms a claw 66. In the second embodiment, the resilient piece 64 and the claw 66 comprise a fixing part.

The fixing parts, namely, the resilient pieces 64 and the claws 66 are arranged on the cylindrical portion 51, at two positions circumferentially spaced by 180°, however, such resilient pieces 64 or fixing parts can be arranged at more than two positions.

As shown in FIG. 6, in the second embodiment, an inner surface of the claw 66 of the fixing part defines a tapered surface (guide surface) 68, for facilitating the claw 66 climbing and passing over the projecting portion 70 that defines the groove 56 of the quick connector 16, when the protection cover 50 is slidingly moved in the axial direction to the left in FIG. 6.

FIG. 6 shows a state that the protection cover 50 is attached on the quick connector 16. At that time, the claws 66 fit-engage in the groove 56 of the quick connector 16 and securely fix the protection cover 50 with respect to the quick connector 16 in the axial direction.

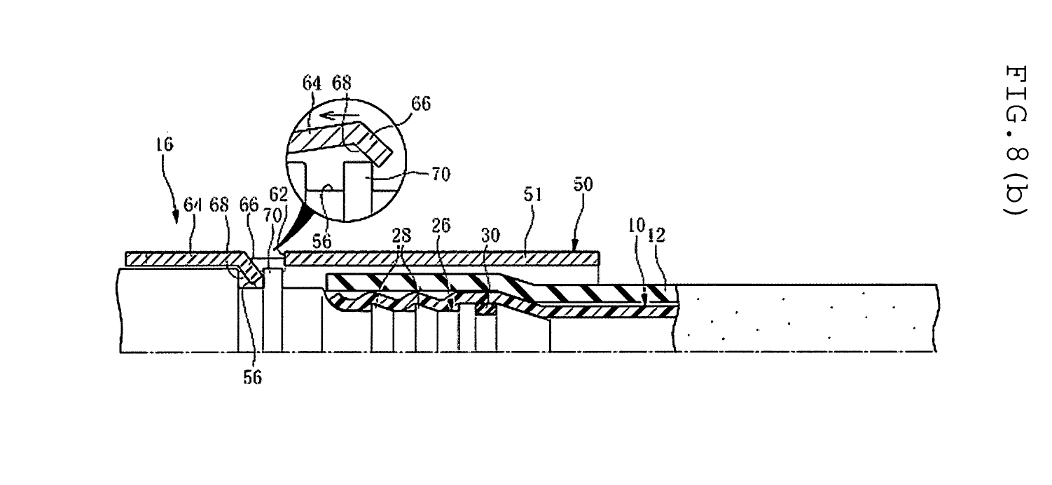

FIGS. 8 (a) and 8 (b) show steps of attaching the protection cover 50 of the second embodiment on the quick connector 16.

As shown in FIG. 8 (a), in the second embodiment, the nipple portion 26 of the quick connector 16 is first press-fitted and securely fixed inside the tube 10, and the tube protector 12 is fitted on the tube 10 so as to cover the tube 10 to an end portion thereof from outside.

And, in this state, the protection cover 50 that has already been fitted on the tube protector 12 is slidingly moved over the tube protector 12 in an axial direction to a left in the figure.

At that time, the claws 66 of the protection cover 50 projecting radially inwardly abut the projecting portion 70 of the quick connector 16, and the resilient pieces 64 are resiliently deformed radially outwardly. Along with resilient deformation of the resilient pieces 64, the claws 66 pass over the projecting portion 70 and fit-engage in the groove 56 with help of guiding action by the tapered surfaces 68.

In this state, the protection cover 50 is securely fixed to or on the quick connector 16 in the axial direction.

According to the second embodiment, the protection cover 50 can be easily fixed to the quick connector 16 simply by sliding the protection cover 50 in the axial direction. And, since equipment for fixing the protection cover 50 by swaging is not required, a cost can be lowered.

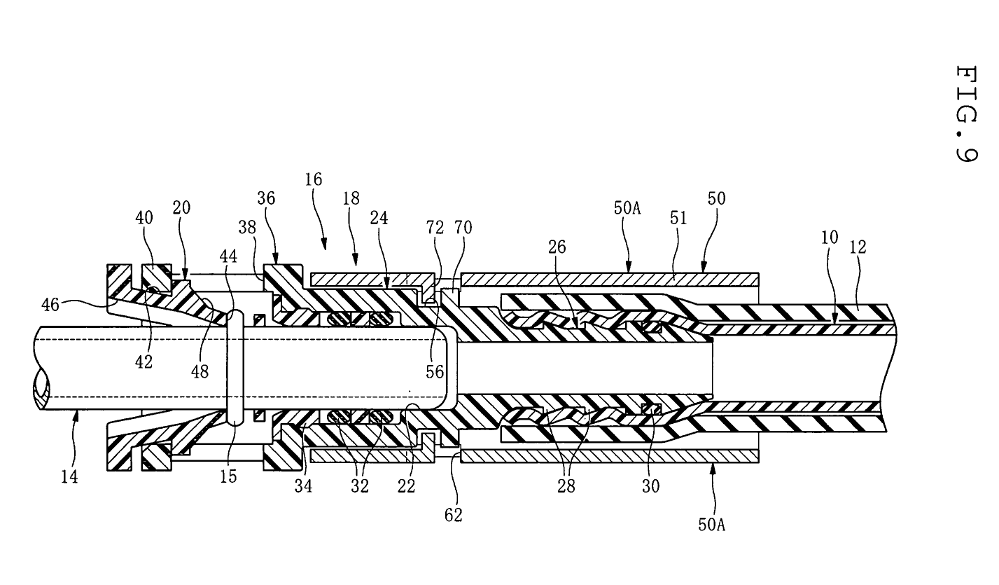

FIGS. 9 to 12 show a protection cover of the third embodiment of the present invention.

As shown in FIG. 9, in the third embodiment, the protection cover 50 for the quick connector 16 is made of inflexible rigid resin (or metal) and formed of a cylindrical shape. The protection cover 50 can be attached on the quick connector 16 in axially fixed relation by fit-engaging claws 72 projecting radially inwardly in the groove 56 of the quick connector 16.

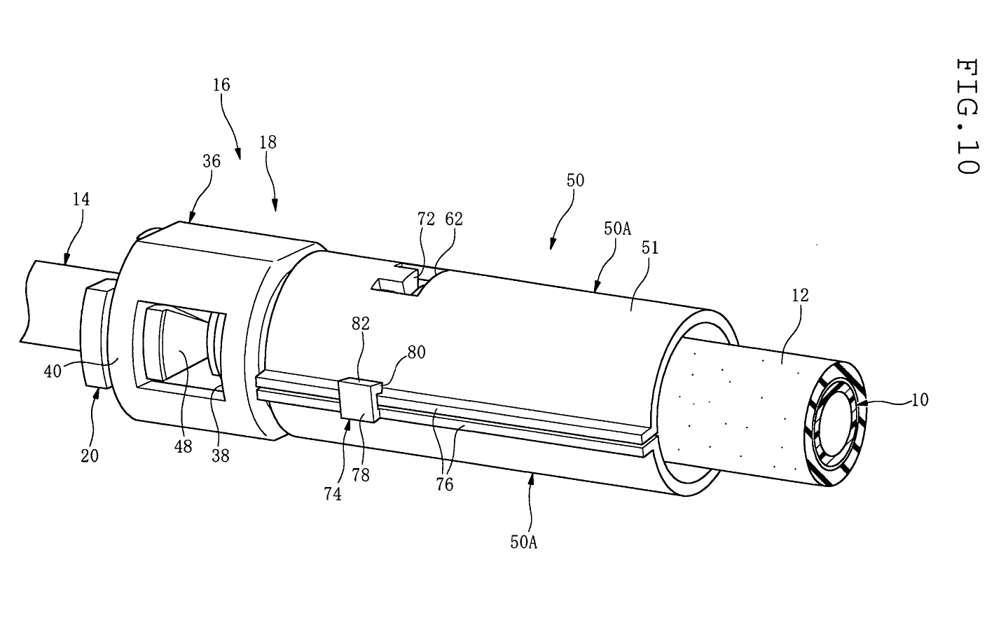

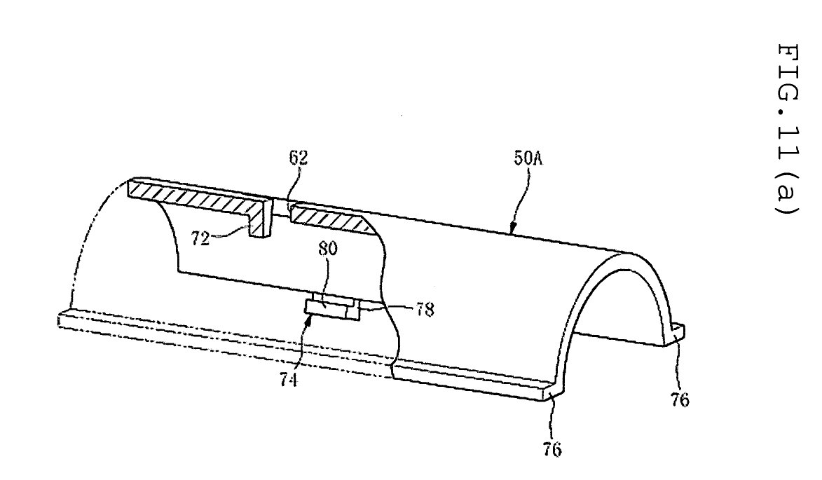

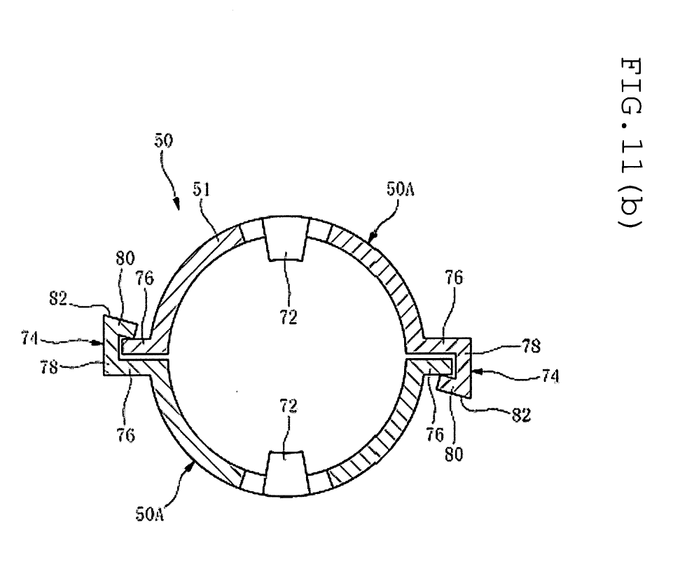

In the third embodiment, as shown in FIGS. 10 and 11, the protection cover 50 is split into a pair of split bodies in a direction perpendicular to an axis of the protection cover 50. The split bodies 50A, 50A are combined each other to construct an entire protection cover 50.

As shown in FIG. 11, each of the split bodies 50A is provided with a joint portion 74 to combine the split bodies 50A each other in the direction perpendicular to the axis.

More specifically, each of the split bodies 50A of semicircular cross-section is formed with projecting rim portions or flange portions 76 projecting radially outwardly on circumferential end portions along an entire length thereof. Further, each of the split bodies 50A is provided with a resilient piece 78 and a latching portion 80 of hook shape on a leading end of the resilient piece 78. The latching portion 80 is resiliently latched onto the flange portion 76 (the flange portion 76 may be regarded as a joint portion) of the split body 50A that is mated, and thereby a pair of the split bodies 50A, 50A are combined each other in the direction perpendicular to the axis with snap-action.

Here, an outer surface of the latching portion 80 of hook shape defines a cam surface 82 as a guide when the split bodies 50A are combined.

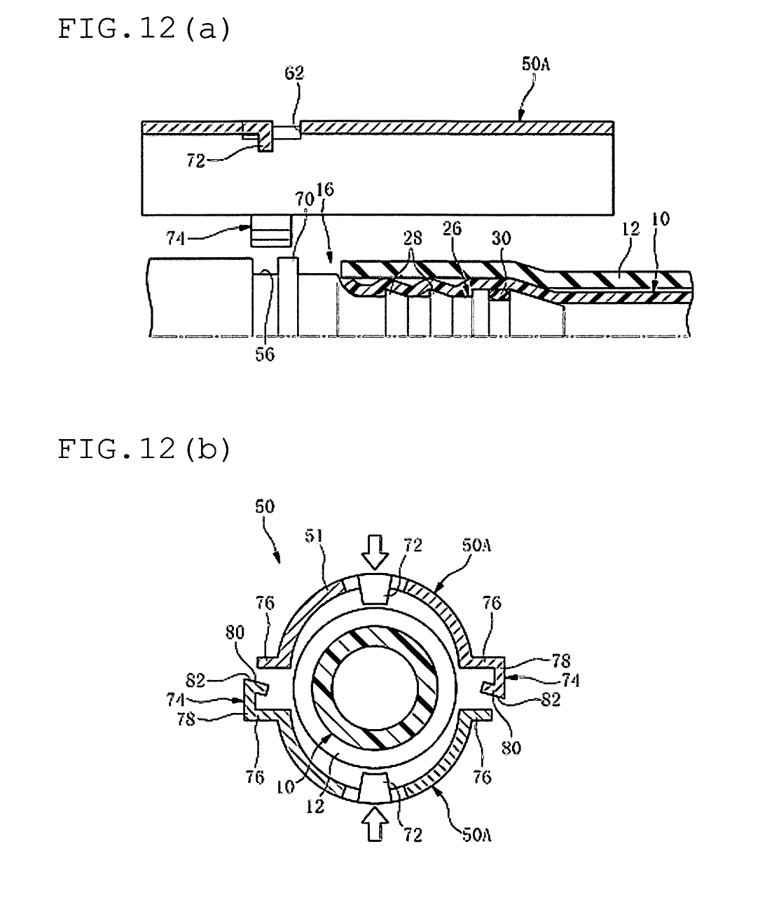

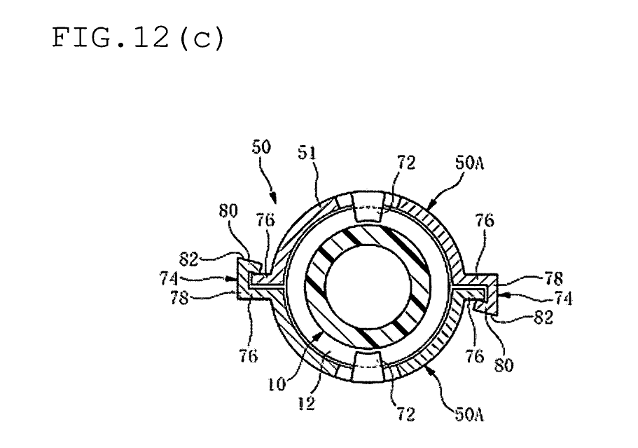

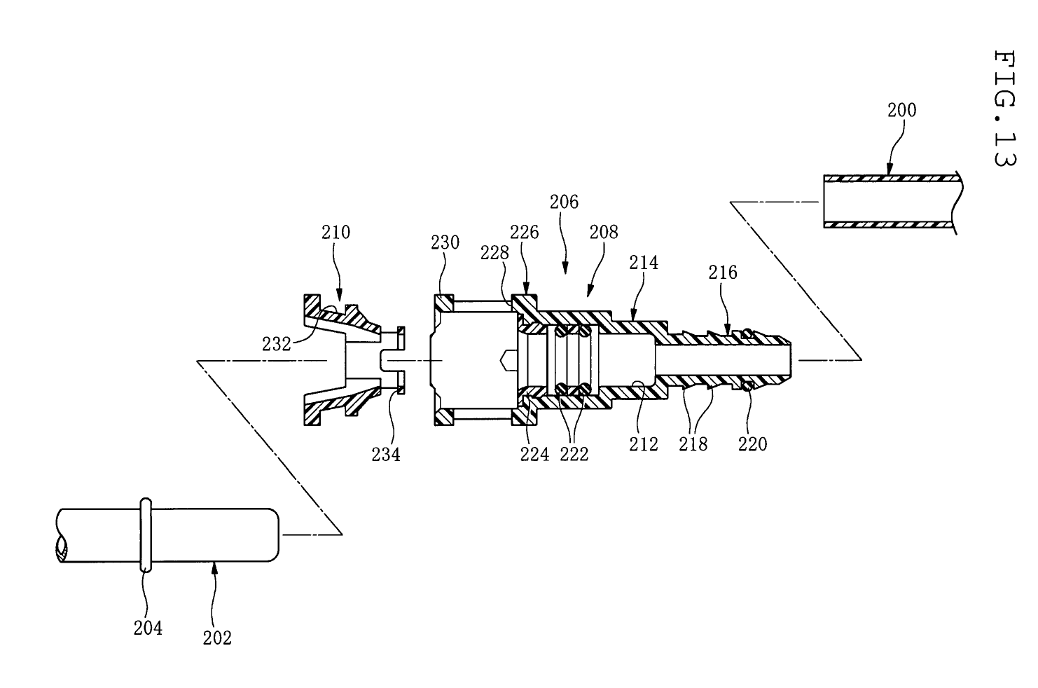

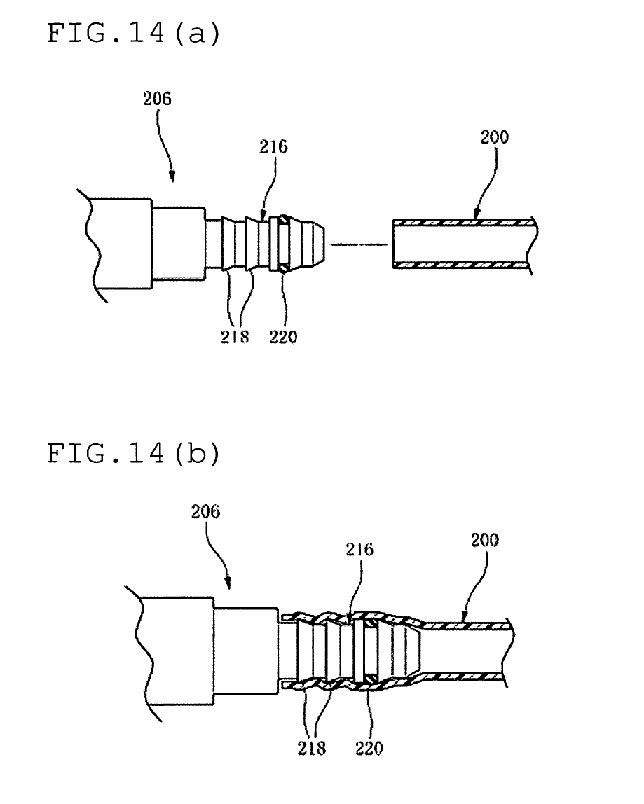

FIGS. 12 (a), 12(b) and 12 (c) show steps of attaching the protection cover 50 of the third embodiment on the quick connector 16.

As shown in FIG. 12 (a), in the third embodiment, similarly to the second embodiment as shown in FIGS. 6 to 8, the nipple portion 26 is first press-fitted and securely fixed inside the tube 10, and the tube protector 12 is also fitted on the tube 10 so as to cover an outer peripheral surface of the tube 10 to an end portion thereof. In this state, the pair of the split bodies 50A,50A are combined each other in the direction perpendicular to the axis.

At that time, the pair of the split bodies 50A, 50A are combined each other through simple operation by action of the cam surfaces 82 of the latching portions 80 of the joint portions 74 and action of resilient deformation of the resilient pieces 78 (refer to FIGS. 12 (b) and 12 (c)).

And, simultaneously with attaching the protection cover 50 on the quick connector 16 by combining the pair of the split bodies 50A, 50A in the direction perpendicular to the axis in this manner, the claws 72 provided on the protection cover 50 fit-engage in the groove 56 of the quick connector 16, and the protection cover 50 is attached on the quick connector 16 in axially fixed relation.

According to the third embodiment, the protection cover 50 (the split bodies 50A, 50A) can be attached on the quick connector 16 after and while the nipple portion 26 of the quick connector 16 is press-fitted in and securely fixed to the tube 10.

Namely, in the first embodiment shown in FIGS. 1 to 5, the protection cover 50 has to be securely fixed to the quick connector 16 by swaging before the nipple portion 26 is press-fitted in and securely fixed to the tube 10. In the second embodiment shown in FIGS. 6 to 8, the protection cover 50 has to be fitted on the tube protector 12 or the tube 10 slidably, prior to press-fitting the nipple portion 26 in the tube 10. On the contrary, in the third embodiment as shown in FIGS. 9 to 12, the protection cover 50 (the split bodies 50A, 50A) can be attached on the quick connector 16 after the quick connector 16 is connected to the tube 10 by press-fitting of the nipple portion 26 in the tube 10. Meanwhile, also in the second and the third embodiments, a proper spacing is defined between the protection cover 50 and the tube protector 12 similarly in the first embodiment.

Although the preferred embodiments have been described above, these are only some of embodiments of the present invention. For example, in the present invention, a protection cover does not need to have a complete cylindrical shape. The protection cover may take various shapes other than the above as far as the protection cover can protect the nipple portion of the quick connector when subject to an external force. The present invention may be constructed and embodied in various configurations and modes within the scope of the present invention.

What is claimed is:

1. A protection cover for a quick connector that comprises (a) an inserting portion defining an inserting space inside in which a mating pipe is inserted in an axial direction of the inserting portion, (b) a retainer resiliently deformable in a radial direction for stopping withdrawal of the inserting portion from the pipe, (c) a nipple portion having a diameter smaller than the inserting portion and including a biting tooth on an outer peripheral surface of the nipple portion, the nipple portion being formed so as to be press-fitted in a tube for piping and securely fixed to the tube in stopped relation with the biting tooth biting an inner surface of the tube,
the protection cover, comprising:
a cylindrical portion as protection body made from inflexible rigid material,
a fixing part to the quick connector,
wherein the cylindrical portion covers an outer periphery of the nipple portion with a spacing defined along an entire circumference between an inner peripheral surface of the cylindrical portion and an outer peripheral surface of the tube fitted on the nipple portion to protect the nipple portion from outside.

2. A protection cover for a quick connector as set forth in claim 1, wherein the fixing part has a claw projecting radially inwardly for fit-engaging in a groove in an outer peripheral surface of the quick connector to fix the protection cover to the quick connector in an axial direction thereof.

3. A protection cover for a quick connector as set forth in claim 2, wherein the protection cover is made of metal, the claw of the fixing part is formed so as to fit-engage in the groove by swaging.

4. A protection cover for a quick connector as set forth in claim 2, wherein the fixing part has a resilient piece resilient radially, the claw is provided on the resilient piece, and the claw is formed so as to fit-engage in the groove by sliding the fixing part in an axial direction with the resilient piece being resiliently deformed.

5. A protection cover for a quick connector as set forth in claim 1, wherein the protection cover is split into split bodies combined in a direction perpendicular to an axis thereof, each of the split bodies is provided with a joint portion for combining the split bodies with one another in the direction perpendicular to the axis.

6. A protection cover for a quick connector as set forth in claim 2, wherein the protection cover is split into split bodies combined in a direction perpendicular to an axis thereof, each of the split bodies is provided with a joint portion for combining the split bodies with one another in the direction perpendicular to the axis.

7. A protection cover for a quick connector as set forth in claim 1, wherein a tube protector made of an elastic material is fitted on the tube in covering relation, and the spacing defined between the cylindrical portion and the tube affords sufficient space for the tube protector to be inserted or located therein.
